(19) United States
(12) Patent Application Publication
(10) Pub. No.: US 2011/0199305 A1
(43) Pub. Date: Aug. 18, 2011

(54) MOUSE CONTROLLED BY MOVEMENTS OF FINGERS IN THE AIR

(76) Inventor: Changsu Suh, Yoosung-gu Deajeon (KR)

(21) Appl. No.: 13/121,906

(22) PCT Filed: Sep. 30, 2009
(86) PCT No.: PCT/KR2009/005582

§ 371 Date: Mar. 30, 2011

(30) Foreign Application Priority Data
Nov. 7, 2008 (KR) 10-2008-0110445

(51) Int. Cl. G06F 3/033

(52) U.S. Cl. 345/158

(57) ABSTRACT

Provided is a new type of finger mouse capable of increasing the user convenience by checking the fine movement information of a finger that freely moves in the air, and by using the fine movement information as coordinate information of a mouse of a computer. The user may easily and conveniently control a mouse pointer regardless of the user's posture or place, departing from the geometrical limitation and the spatial limitation of the wireless mice, through the technology of the present disclosure.

### TECHNICAL FIELD

The present disclosure relates to a new type of computer pointing input device based on movements of fingers.

### BACKGROUND ART

With the rapid development of semiconductors and sensors in recent years, numerous electronic devices have been changed into various schemes for user convenience. The trend has been also applied to the field of a mouse, which is a main input device of computer. The function and the shape of a mouse product are being developed from an early version of a ball mouse to an optical mouse and a laser mouse which remove inconvenience of the ball mouse, a wireless mouse where a connection line between a mouse and a computer is removed, and a touch pad available from Apple Inc. implementing a pointing function in a portable computing environment or a track pointer available from IBM Corp., etc. However, since these mice are essentially operated only on a flat surface, the use of these mice is still inconvenient. This results from the stereotyped idea in that the user uses a mouse, sitting in front of a computer. It is disadvantageous in that the user may not easily control a computer due to a limitation in the user's posture and a limitation in a space.

An approach of the related art that has been attempted to reduce the disadvantages of the existing mice and a problem of the existing pointing technologies using fingers will be described below.

First, Korean Utility Model Application No. 2004-0028074 proposed a new type of mouse where a remote controller is combined with a mouse. The proposed mouse has an air mouse function capable of performing a pointing control even in the air. Similarly, Korean Patent Laid-Open No. 2004-0066986 proposes a device where a laser point for presentation is combined with a mouse. The proposed device may also perform the pointing control in the air. The device uses a scheme in which horizontal/vertical sensors are provided inside the mouse to produce the movements of the whole hand holding the device, thereby using the produced information as the movement signal of the mouse. It is advantageous in that there is no need to use these mice on a flat surface. However, the size and the weight of a mouse are almost similar to the existing mouse, such that the user may not use these mice for a long period of time. In addition, similar to the existing mouse, it is still inconvenient in view of the limitation in the user's posture and in that the user needs to hold the mouse continuously, since the user needs to hold the mouse by hand to operate.

Meanwhile, Japanese Patent Laid-Open No. 2007-109188 proposed a pistol type mouse that is controlled by the movements of fingers. The proposed mouse uses left/right thumbs to control mouse coordinates and perform a mouse click function using an index finger. Unlike the existing mice, it is advantageous in that the mouse is controlled by fingers. However, it is difficult to move the mouse pointer in a diagonal direction and it is inconvenient for the user to continuously hold the mouse for performing the mouse pointing like the air mouse.

Meanwhile, US Patent Publication No. 20030214481 proposed a thimble mouse attached to fingers. The proposed mouse includes a device capable of measuring a touch pressure of a finger like a track pointer available from IBM Corp., to control a computer pointer using a touch pressure between fingers. Since the mouse is attached to the fingers, it has an excellent portability and does not have to be continuously held by hand. However, the scheme of controlling the mouse through the pressure of fingers has a limitation in a precise pointing. In addition, when the user uses the mouse, it is a counter-intuitive, and, thus, the efficiency is degraded. In contrast, since the technology of the present disclosure measures the fine movement information of fingers moving in the air to reflect the information to the mouse pointer, it is more effective in that the user may even more finely and intuitively control the mouse pointer.

Meanwhile, Korean Patent Laid-Open No. 2005-0025837 proposed a technology of mounting a mouse pointer to fingers and checking X/Y information of an accelerometer to check the movement of the fingers touching a virtual touch pad. However, since all the accelerometers on earth are subjected to the influence of acceleration of gravity (9.8 m/s2), the measured X, Y acceleration values are essentially added with movement acceleration changed due to the actual movement of fingers and acceleration of gravity generated by the size of cos θ from a vertical direction of the ground. That is, since only the movement acceleration of fingers cannot be finely measured, it is impossible to perform the fine pointing. Of course, when the fingers move, putting on the bottom (e.g., a virtual touch pad), the errors of the acceleration of gravity may be reduced to some degree by using a filter and an algorithm. However, when the fingers are in the air, it is impossible to finely control the mouse pointer, and, as a result, the technology may be used only on the bottom. The movement sensing unit of the present disclosure is evaluated as overcoming the problems of Korean Patent Laid-Open No. 2005-0025837 in that the finger pointing device can be used both on the bottom and the air, by measuring the movement of fingers using a Gyro sensor and correcting the movement of fingers using an acceleration sensor.

### DETAILED DESCRIPTION

### Technical Problem

The present disclosure has been made in an effort to provide a new type of finger mouse device and a method being applied to pointing by measuring the movement of fingers regardless of a user's posture or space. The present disclosure (1) fixes and attaches a relatively miniaturized mouse to fingers as compared with the existing wired and wireless mice, and (2) measures the fine movement of the attached fingers, and then, transfers the measured information to a computer through RF communication or USB communication to use the transferred information as coordinate information of a pointer. In addition, the present disclosure has (3) a specific switch capable of applying the movement of fingers to a mouse pointer only if the user wants.

### Means to Solve the Problem

In order to miniaturize the present disclosure, it is preferable to use a chip such as a system on chip (SOC) type where a microprocessor, a communication device, a touch sensor, etc., are integrated on a single chip. In particular, a capacitance based touch function may be implemented in a general microprocessor even though a specific chip is not used, if the corresponding principle may be understood. Technology documents are distributed and may be referred at the homepages of Microchip Technology Inc. or STMicroelectronics where touch technologies, of which the patent rights have expired, are implemented in a general microprocessor. When using a chip in which several functions needed in the present disclosure are integrated in an SOC type, it is possible to largely reduce the size of the electronic circuits of the present disclosure and miniaturize the product.

In order to measure the movement of fingers through a small mouse attached to fingers, a Gyro sensor or an accelerator sensor is needed. However, the accelerator sensor is subjected to the influence of acceleration of gravity (9.8 m/s2) of the earth, such that only the movement of the fingers may not be accurately measured. Some patents assert that only the movement acceleration excluding the acceleration of gravity may be measured through a 3-axis acceleration sensor based on mathematical equation 1 as shown below. However, this corresponds to theoretical contents under the assumption that there are no errors in the value measured by the acceleration sensor. An inexpensive Micro Electro Mechanical Systems (MEMS) based accelerator sensor actually used in mass production clearly has some errors, which has a limitation to accurately measure only the movement acceleration.

\sqrt{sin θ²+cos θ²+tan θ²}=1 g Mathematical Equation 1

Therefore, in order to accurately measure the movement of fingers, it is preferable to use a Gyro sensor that is not subjected to the influence of the acceleration of gravity as a main measuring device, and use an acceleration sensor as an auxiliary device to increase the measurement accuracy of the Gyro sensor. Even though the inexpensive MEMS based Gyro sensor actually used in mass production clearly has some errors, this error corresponds to an error applied with reference to the movement rather than the gravity, which may be overcome by an appropriate algorithm and a filter. As an example, after removing some errors by first passing the data measured in the Gyro sensor through a low pass filter, it is possible to increase the accuracy of measured data when a Kalman filter algorithm which is based on distribution information of the latest data is applied. When the filter or the algorithm is used, it is possible to perform a more accurate measurement than when the measurement value of the acceleration sensor is used as the auxiliary information. In this case, since a scheme of using the acceleration value as the auxiliary information while based on the Gyro sensor and a scheme of using the angular velocity value of the Gyro sensor as the auxiliary information while based on the acceleration sensor may consequently obtain similar results, such that there may be a slight controversy. However, it is an obvious fact that the present disclosure may be implemented through only the Gyro sensor but may not be implemented through the acceleration sensor only. For this reason, the present disclosure specifies that the Gyro sensor is used as the main measuring device and the acceleration sensor is used as the auxiliary device to increase the measurement accuracy of the Gyro sensor.

In order to efficiently use the present disclosure, the movement of the fingers should be reflected to the mouse pointer only if the user wants. This is to easily perform a typing operation or other operations such as a phone call, etc., while the mouse of the present disclosure is attached to the user. To this end, it is preferable that a switch configured to controls whether the pointing is reflected is implemented as a touch switch that may be operated by fingers or only a light touch to a body.

### Advantageous Effects

The ‘mouse controlled by the movement of fingers in the air’ according to the present disclosure may promote a user convenience while overcoming the spatial limitation of the existing wired and wireless mice, by considerably miniaturizing the mouse and attaching the mouse to the fingers.

The ‘mouse controlled by movement of fingers in the air’ according to the present disclosure may minimize the excessive hand movements needed to control the mouse pointer by measuring the fine movement of the fingers such as, for example, the left/right movement and the slope of the fingers, through the Gyro sensor and the acceleration sensor, and by using the corresponding information as the coordinate information of the mouse.

The ‘mouse controlled by movement of fingers in the air’ according to the present disclosure may maximize the convenience of a mouse function by controlling whether the mouse pointer is operated only by the light touch between the fingers using the touch sensor.

### BRIEF DESCRIPTION OF DRAWINGS

FIG. 1 is a main configuration diagram of a mouse controlled through the movement of fingers in the air, according to an exemplary embodiment of the present disclosure.

FIG. 2 is an exemplified diagram showing a position of the mouse controlled through the movement of fingers, according to the exemplary embodiment of the present disclosure.

FIG. 3 is an exemplified diagram showing a state in which fingers are fixed onto the mouse controlled through the movement of fingers in the air, according to the exemplary embodiment of the present disclosure.

FIG. 4 is an exemplified diagram showing an operation start/end of the mouse pointer controlled through the movement of fingers in the air, according to the exemplary embodiment of the present disclosure.

FIG. 5 is a flow chart showing the sequence of measuring the movement of fingers on a mouse controlled through the movement of fingers in the air, according to the exemplary embodiment of the present disclosure.

FIG. 6 is an exemplified diagram showing a case where a microprocessor of an SOC type is applied to the mouse controlled through the movement of fingers in the air, according to the exemplary embodiment of the present disclosure.

FIG. 7 is a configuration diagram showing a device of a wireless USB type connected to a computer, when the mouse controlled through the movement of fingers in the air, according to the exemplary embodiment of the present disclosure, is operated based on a wireless communication.

### EXEMPLARY EMBODIMENTS

Prior to describing the present disclosure with the accompanying drawings, it is to be noted that matters unnecessary to show the subject matters of the present disclosure, that is, known components that can be apparently understood by those skilled in the art are neither shown nor described in detail.

FIG. 1 is a main configuration diagram of a mouse controlled through the movement of fingers in the air, according to an exemplary embodiment of the present disclosure.

A Gyro sensor and an acceleration sensor 1 sense the movement of fingers to which the mouse of the present disclosure is attached. The movement sensing unit of the present disclosure uses as a main measuring device the Gyro sensor capable of finely checking the movement of fingers while not being subjected to the influence of the terrestrial gravity. The Gyro sensor, which is a device capable of measuring the angular velocity by which objects move, may accurately measure the movement coordinate value of the fingers regardless of the slope or the surrounding environment, such that it may finely check the movement of fingers in the air. The present disclosure uses the Gyro sensor as the main movement sensing unit, and when the present disclosure further includes the acceleration sensor, the acceleration sensor is used as an auxiliary device increasing the accuracy of the movement measurement by cooperating with the Gyro sensor. Click switches 2 and 3, which are switches for implementing a mouse left click and a mouse right click, respectively, may be implemented through a mechanical switch or a touch sensor. Meanwhile, touch pad 4 is provided with a touch switch to sense whether the user's body touches touch pad 4 by calculating the capacitance according to the change in a dielectric constant of the pad when user's body approaches to touch pad 4. The position of the touch pad shown in FIG. 1 is only an example, and, therefore, the position thereof may be variously changed according to the structure of the mouse. A sensor control IC serves as a function to control touch buttons. As an example, an AT42QT1060 chip available from Quantum Corp., may simultaneously control six (6) touch sensors by a single IC, while consuming very small power, which may be adopted to the exemplary embodiment. If the capacitance based touch technology is known, the touch function may be directly implemented in the general microprocessor. A microprocessor 6 controls the operation of Gyro sensor and acceleration sensor 1, click switches 2 and 3, and a touch sensor 5, and transfers processed information to a computer through a communication chip 7, thereby processing the information of a mouse pointer and an operation such as a click. In this configuration, communication chip 7 may have functions such as, for example, an RF wireless communication, an USB wireless communication, an USB wired communication. A battery 8 supplies power to the mouse when performing the wireless communication. However, when the mouse is driven by a USB connection, the power of a computer body may be used directly.

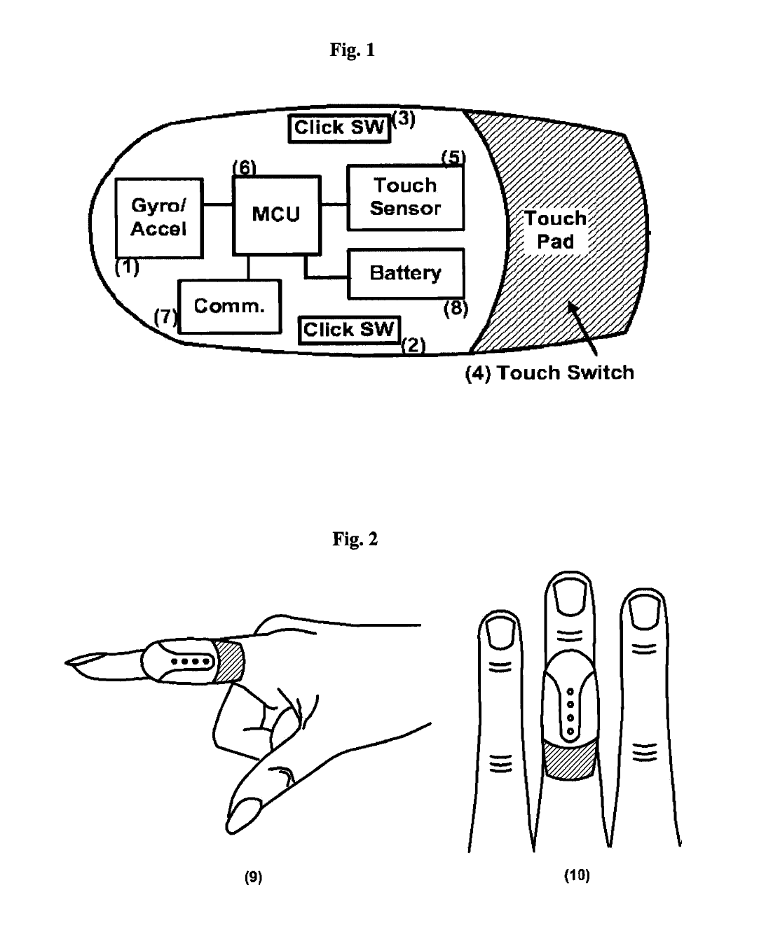

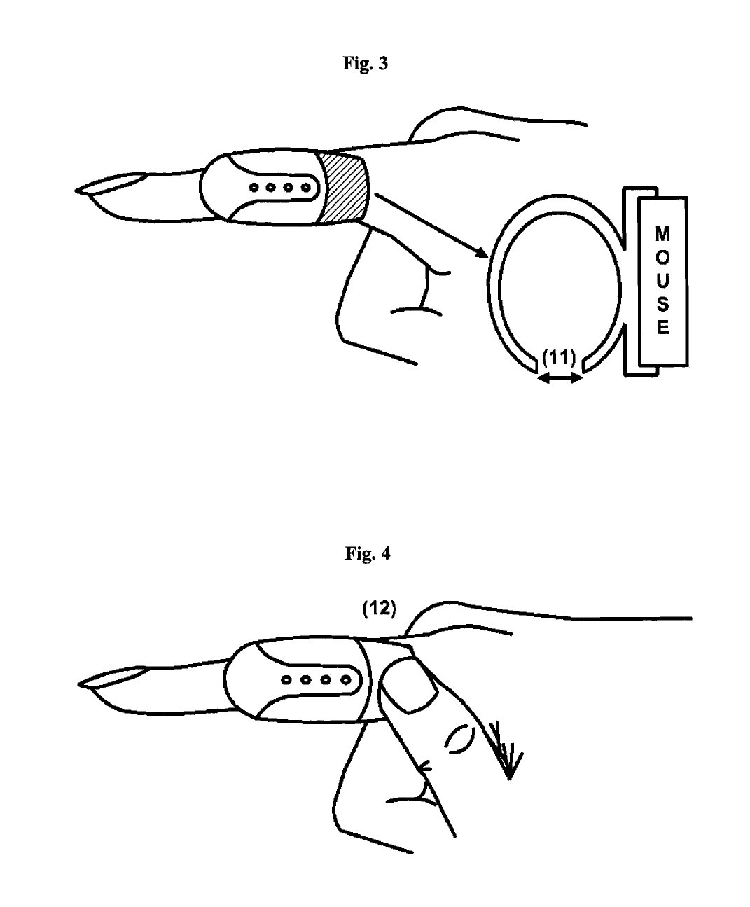

FIG. 2 is an exemplified diagram showing a position of the mouse controlled through the movement of fingers, according to the exemplary embodiment of the present disclosure.

It is apparent that the mouse implemented by the present disclosure may be operated while a single mouse or a plurality of mice are attached to any finger in order to sense the movement of fingers. FIG. 2 is an exemplified diagram showing a case where the mouse of the present disclosure exists on an index finger 9 or a middle finger 10.

FIG. 3 is an exemplified diagram showing a case where the mouse controlled through the movement of fingers, according to the exemplary embodiment of the present disclosure, is fixed.

The easiest scheme for fixing the mouse to the fingers is to fix the mouse to the fingers by using a ring-shaped fixing device such as a ring. As shown by reference numeral 11 of FIG. 3, the ring-shaped fixing device may be fixed regardless of the thickness of fingers when it is efficiently configured to be slightly increased or reduced, according to the thickness of fingers, by leaving a slight space at the end of the ring-shaped fixing device. The ring-shaped fixing device is only an example, and, therefore, in order to fixedly attach the mouse of the present disclosure to the fingers, a device having various structures may be used and the fixing device may be configured in order to fixedly attach the mouse to one finger, or two or more fingers. Further, the inside of the fixing device may be designed to dispose other components so that the fixing device of the mouse may perform other functions in addition to the fixing attachment function.

FIG. 4 is an exemplified diagram showing the operation of a switch that controls whether the pointing of the mouse pointer controlled through the movement of fingers in the air according to the exemplary embodiment of the present disclosure, is applied.

A user performs various activities such as using a mouse, typing a keyboard, answering the phone, or the like, such that the unintended movement signal may be provided to the mouse of the present disclosure. Therefore, in order to prevent this, a switch capable of controlling the start/end of the operation of the mouse pointer is mounted on the specific portion of the mouse, and it should easily control the switch as shown in FIG. 4. For the convenience, it is preferable that the corresponding switch may be a touch switch controlled through the touch of fingers or a body. However, the function may be implemented by using a general switch, or the function may be implemented by a sequence or time of pressing the existing left/right click switches. That is, the implementation or structure of the button and the button position, etc., may be implemented in various types.

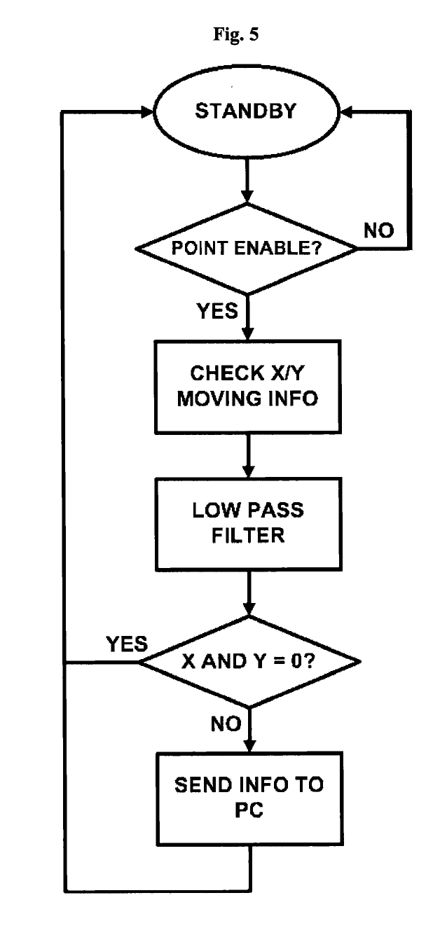

FIG. 5 is a flow chart showing an order of measuring the movement of fingers on a mouse controlled through the movement of fingers in the air, according to the exemplary embodiment of the present disclosure.

First, a control unit confirms a switch, controlling whether the operation of the mouse pointer is applied, to determine whether the user currently points the movement of fingers. If the pointing is in an enabled state, X/Y low data are measured by the movement sensing unit, and the noise is removed through a low pass filter. If both the X/Y are not zero (0), the corresponding information is transferred to the computer through the RF or the USB communications, and returns to a standby state.

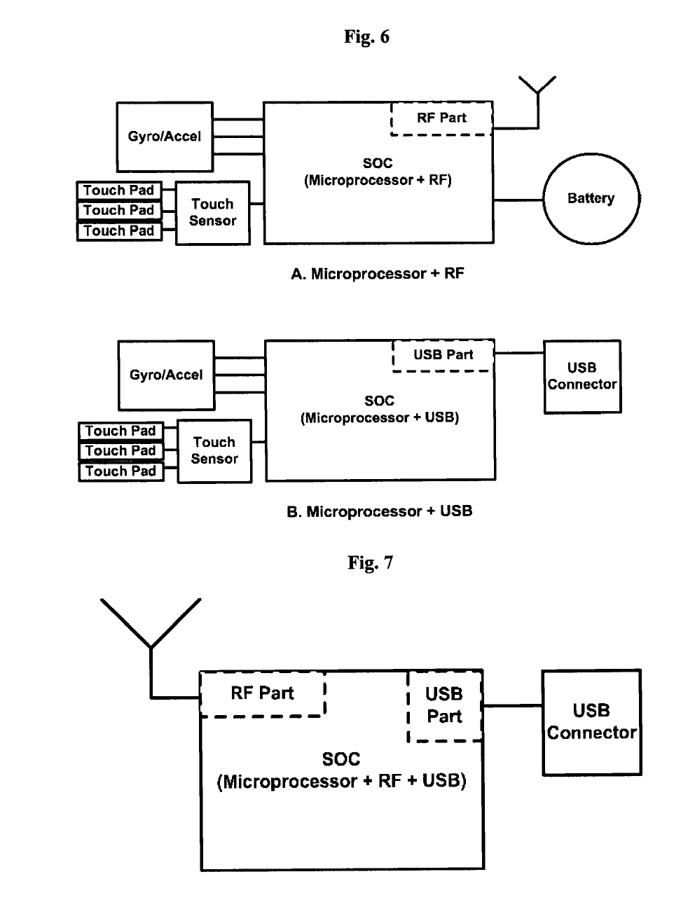

FIG. 6 is an exemplified diagram showing a case where the microprocessor of an SOC type is applied to the mouse controlled through the movement of fingers in the air, according to the exemplary embodiment of the present disclosure.

The microprocessor, the RF and USB communication function, and/or the USB connection function, etc., are configured in a SOC type to be integrated on a single chip, such that the present disclosure may be even more miniaturized. As an example, chips such as CC2430 or CC2431 available from Texas Instruments Inc. simultaneously provide the wireless communication function of 2.4 GHz based on a microprocessor of 8051 core. Also, some chips available from Cypress Semiconductor Corp. or Nordic Semiconductor ASA include the USB and wireless communication functions inside the microprocessor. These chips may be applied to the present disclosure.

FIG. 7 is a configuration diagram showing a wireless USB type device connected to a computer, when the mouse controlled through the movement of fingers in the air, according to the exemplary embodiment of the present disclosure, is operated based on a wireless communication. Nordic Semiconductor ASA produces the SOC chip and nRF24LU1 having the USB communication and RF communication functions included in the microprocessor, which may be applied to the present disclosure.

Meanwhile, only the main matters of the present disclosure are described with reference to FIGS. 1 to 7, and various designs may be available within the technical scope, and, therefore, it is apparent that the present disclosure is not limited to the configuration of FIGS. 1 to 7.

1. A mouse comprising:
a movement sensing unit, which is based on a Gyro sensor and uses an acceleration sensor to correct an error, configured to sense a left/right movement and a slope through the movement of a finger in the air;
a touch sensing unit configured to sense a touch of the finger and a body;
a mouse pointer operation start/end unit configured to start/end the operation of a mouse pointer according to the movement of the finger in the air; and
a control unit configured to control the mouse pointer through the movement sensing unit, and control the mouse function through the touch sensing unit and the mouse pointer operation start/end unit,
wherein the mouse is fixedly attached to the finger and controlled through the movement of the finger in the air.

2. A mouse comprising:
a mouse main body equipped with a movement sensing unit and a control unit therein:
a touch sensing unit, provided in a right side and a left side of the mouse main body, configured to serve as a right click or a left click of the mouse;
a mouse pointer operation start/end unit provided in a side of the mouse main body configured to start/end the operation of a mouse pointer; and
a fixing unit configured to adjust the mouse main body to put the mouse main body to the finger,
wherein the mouse is fixedly attached to the finger and controlled through the movement of the finger in the air.

3. The mouse according to claim 2, wherein the movement sensing unit utilizes a Gyro sensor to sense a left/right movement and a slope, and an acceleration sensor to correct an error, and
the control unit controls the mouse pointer based on a movement of the finger, and controls a mouse function according to a touch or ON/OFF.
